(19) United States
(12) Patent Application Publication
(10) Pub. No.: US 2024/0154428 A1
(43) Pub. Date: May 9, 2024

(54) POWER CONTROL SYSTEMS AND METHODS INCLUDING EXAMPLES OF AUTONOMOUS CONTROL OF POWER SUPPLIED FROM MULTIPLE SOURCES

(71) Applicant: Renew Power Systems, Inc., Minneapolis, MN (US)

(72) Inventors: Gregory S. Mowry, Burnsville, MN (US); Zachary J. Emond, Apple Valley, MN (US)

(21) Appl. No.: 18/501,883

(22) Filed: Nov. 3, 2023

Related U.S. Application Data
(60) Provisional application No. 63/382,267, filed on Nov. 3, 2022.

(51) Int. Cl. H02J 3/40; H02J 3/32; H02J 3/38; H02J 7/00

(52) U.S. Cl. CPC H02J 3/40; H02J 3/32; H02J 3/381; H02J 7/0048; H02J 7/00712; H02J 2203/10; H02J 2207/20

(57) ABSTRACT

Examples described herein include autonomous power control techniques for a decentralized power network. An example power network includes first and second power sources, a power bus, a communication bus, and first and second corresponding power control systems. In some examples, the first power control system includes an inverter that provides a first alternating-current (AC) signal from the first power source, and synchronization circuitry coupled to a power bus and synchronizes the first AC signal with a second AC signal on the power bus. The first power control system further includes a controller coupled to the inverter and provides first capacity information associated with the first power source to the second power control system, receives second capacity information associated with the second power source from the second power control system, and controls an amount of power to the power bus based on the first and second capacity information.

### CROSS-REFERENCE TO RELATED APPLICATIONS

This application claims the benefit under 35 U.S.C. § 119 of the earlier filing date of U.S. Provisional Application Ser. No. 63/382,267, filed Nov. 3, 2022, which application is hereby incorporated by reference in its entirety for any purpose.

### BACKGROUND

Recently, individual systems' abilities to interact with one another for cooperation between systems and to integrate into a larger and more complex network have spread widely. Such systems often have non-linear characteristics. Such systems' interactions can result in, but are not limited to, self-organization, collective behavior, and adaptation as seen in mainstream applications, such as artificial intelligence, big data and blockchain technologies.

Issues around complex power networks are relatively new and expansive, due to recent development of a variety of distributed power generation systems. Such complexity in power networks has been found to be one of the foundational pillars of contemporary infrastructure. However, unlike many centralized systems common to our current infrastructure, power network control that is distributed across power supply systems is relatively new. This may be due to power systems' analog nature, the variety of power supply capacities of a variety of distributed power sources, and the timeliness demanded across systems.

Distributed energy resource management generally includes a centralized power control system in a power supply network. This centralized power control system may monitor overall loads and power sources for effective power supply to various loads based on characteristics of input power sources and current loads. All power supply systems in the power supply network may, for example, provide synchronized power supply based on a reference clock (e.g., atomic clock) in the network. Such systems may not be resilient, given that they utilize a centralized power control system.

### BRIEF DESCRIPTION OF THE DRAWINGS

FIG. 1 is a schematic diagram of a power control system, according to examples described herein.

FIG. 2 is a schematic diagram of a controller, according to examples described herein.

FIG. 3A is a schematic diagram of a power supply network system, according to examples described herein.

FIG. 3B is a table of simulation conditions of power control systems of a power supply network system, according to examples described herein.

FIG. 3C is a diagram of a power balance among the power control systems of the power supply network system, according to examples described herein.

FIG. 3D is a diagram of residuals of the power control systems of the example power supply network system, according to examples described herein.

FIG. 4 is a schematic diagram of a power control system, according to examples described herein.

FIG. 5 is a schematic diagram of a power grid system, according to examples described herein.

FIG. 6 is a schematic diagram of a power grid system, according to examples described herein.

FIG. 7 is a schematic diagram of self-synchronizing inverters, according to examples described herein.

FIG. 8 is a schematic diagram of a system including self-synchronizing systems, according to examples described herein.

FIG. 9A is a schematic diagram of multiple power control systems according to examples described herein.

FIG. 9B is a schematic diagram of multiple power control systems according to examples described herein.

FIG. 10 is a schematic diagram of an electrical system including self-synchronizing drivers, according to examples described herein.

FIG. 11 is a schematic diagram of an electrical system including self-synchronizing drivers, according to examples described herein.

### DETAILED DESCRIPTION

Certain details are set forth below to provide a sufficient understanding of embodiments of the disclosure. However, embodiments of the disclosure may be practiced without certain of these particular details in some examples. Moreover, the particular embodiments of the present disclosure described herein are provided by way of example and should not be used to limit the scope to these particular embodiments. In other instances, well-known materials, components, processes, controller components, software, circuitry, timing diagrams, power sources, power methods and/or software operations have not been described or shown in detail in order to avoid unnecessarily obscuring the embodiments.

Examples described herein include power supply systems that may utilize autonomous, intelligent control. Example systems may reduce or eliminate reliance on a centralized control system to coordinate power provided to a load from a network of power supply systems (e.g., nodes). Examples of such power supply systems may have beneficial attributes. Because individual power control systems (e.g., nodes) may themselves evaluate capacity and load conditions to make decisions about power delivery, the network of power control systems may be resilient to the failure of one or more nodes. For example, the robustness of a network of power supply systems may increase as the number of power control systems in the network increases.

Moreover, the interconnected power control systems may dynamically enforce synchronization of supplied AC signals, resulting in high stability and autonomous power sharing in some examples. Because the synchronization and power supply control are naturally distributed and/or decentralized with autonomous self-sufficient power control systems in examples of networked systems described herein, another power control system may join in the power supply network system with less instability, points of failure and/or cascading failures.

In some examples, a power supply network may include a plurality of power control systems coupled to a power bus and a communication bus. The power control systems may be used to supply power to the power bus from one or more power sources. For example, one power control system may be used to provide power to the power bus from a single power source in some examples, and from multiple power sources in some examples. Multiple power control systems may be coupled to the power bus and used to provide power to the power bus from all the power sources coupled to the multiple power control systems. Each power control system in the power supply network typically includes an inverter. In such cases, the inverter may receive power from a power source and provides an alternating-current (AC) signal to the power bus. Each power control system may include synchronization circuitry. The synchronization circuitry may be coupled to the power bus. The synchronization circuitry may synchronize an AC signal provided by the power control system with another AC signal on the power bus. Each power control system may include a controller. The controller may provide capacity information, also referred to as state information, associated with the power source to the communication bus. In some examples, the capacity information may include operating state information, constraint information, and storage capacity and constraint information. The controller may receive other capacity information associated with one or more other power sources from the communication bus. The controller may control an amount of power to the power bus based on the capacity information associated with the power source and the other capacity information.

In this manner, each power control system may provide its capacity information to one or more other power control systems in a network. Similarly, each power control system may receive capacity information from one or more other power control systems in the network. Accordingly, each power control system may determine an amount of power from its connected power sources to supply to the power bus. Because the decision may take capacity information from other power sources into account, the power control system may operate autonomously, and the overall network may exhibit resilience in some examples.

In some examples, the power control system may perform software-based control of an amount of power to be supplied on the power bus. In some examples, the controller may control the amount of power, at least in part by evaluating a cost function. For example, the controller may be implemented as a microprocessor or a microcontroller including or coupled to a computer-readable storage medium. The computer-readable storage medium may store executable instructions to perform control of power circuits, such as the inverter, the synchronization circuitry, and switches (e.g., breakers). The computer-readable storage medium may store executable instructions to provide internal and/or external communications, such as transmit and/or receive control signals and other information, such as capacity information. The computer-readable storage medium may store executable instructions for cost function evaluation. The computer-readable storage medium may store data, such as parameters, such as capacity information.

A variety of capacity information may be exchanged between power control systems in examples described herein. In some examples, the capacity information may include a present time (e.g., a timestamp). In some examples, the capacity information may include a location of a power source controlled by the power control system (e.g., a geographical location, a room, a building, a city, a country, a state). In some examples, the capacity information may include a maximum power output of the connected power source, and/or minimum power output from the connected power source.

In some examples, controllers described herein may receive demand information. Generally, the demand information may be information regarding a power demand from one or more loads connected to the power bus. The controller may control the amount of power provided from a connected power source to the power bus based on the demand information. In some examples, the controller may include a processor and a computer-readable storage medium that stores instructions that when executed by the controller, cause the controller to receive the capacity information, store the capacity information in a portion of the computer-readable storage medium, and/or provide the capacity information to the communication bus. In some examples, the instructions may additionally or instead cause the controller to receive other capacity information from the communication bus (e.g., from other power control systems), and control the amount of power to the power bus based on the capacity information and the other capacity information.

In some examples, the instructions further cause the controller to evaluate a cost function using the capacity information from the controller's node and the other capacity information from one or more other nodes. The instructions may cause the controller to control the amount of power based on the evaluation of the cost function. In some examples, the instructions cause the controller to receive demand information about at least one load via the communication bus, and evaluate the cost function based on the demand information. In some examples, the demand information represents a total demand amount by loads in a power grid system including the power supply network.

In some examples, the instructions may further cause the controller to control the inverter and/or the synchronization circuitry to control the amount of power, based on the evaluation of the cost function. The evaluation of the cost function may vary based on the location or time of the power source(s), the maximum power output from the power source(s), the minimum power output from the power source(s), time of a day, demand information, etc. Regardless of the type of power source, for example, a solar photovoltaic cell (PV), a diesel generator, a fuel cell, a wind turbine, a hydroelectric facility, a bio-power source, an energy storage system (ESS), or any combination thereof, using the cost function, the controllers in the power supply network may control power provided on the power bus by each of the power sources.

In some examples, the power control system may also include a power line coupled to the inverter and the synchronization circuitry. The inverter may receive a direct current (DC) signal (e.g., DC current or DC voltage) from the power source. The inverter may convert the DC signal into an AC signal (e.g., AC current or AC voltage), and provide the AC signal to the power line. The synchronization circuitry coupled to the power line may receive the AC signal from the power line and synchronize the AC signal with the other AC signal on the power bus.

Examples of synchronization, including the self-synchronization of an AC signal provided by an inverter with that on the power bus, are described in U.S. Pat. No. 11,228,183, issued Jan. 18, 2022 and entitled “Self-synchronizing devices, systems, and methods,” which patent is hereby incorporated by reference in its entirety for any purpose.

In some examples, the power control system may perform hardware-based control and/or synchronization of power supplied to the power bus. In some examples, the synchronization circuitry may include a non-linear circuit and/or a chaotic circuit. In some examples, the inverter may include the synchronization circuitry. In some examples, the power control system may also include one or more AC power generators that convert mechanical energy to electrical energy. In some examples, the synchronization circuitry may synchronize an AC signal from the one or more AC power generators with the AC signal on the power bus. The synchronization circuitry may provide the synchronized AC signal to the power bus.

In some embodiments, the power control system may include energy storage. The capacity information may include power storage capacity of the energy storage. In some examples, the energy storage may be implemented using at least one of a battery, a flywheel, a pumped hydroelectric system, a standard hydroelectric system, compressed gas storage, or any combination thereof. Other energy storage devices may additionally or instead be used. In some examples, the power control system may further include a charge controller coupled to the energy storage that controls an amount of power stored in the energy storage. The amount of power stored in the storage may be based on the amount of power provided to the power bus and/or the capacity information in some examples. In some examples, the controller may include the charge controller. In some examples, the inverter, synchronization circuitry and/or the charge controller may be coupled to one or more control lines. The controller may control the inverter and/or synchronization circuitry to provide and/or adjust an amount of power to store and/or to provide to the bus. The controller may control the charge controller to adjust an amount of power to store by sending control signals via the one or more control lines, which may be implemented using a control bus.

Each controller of each of the plurality of power control systems may control the amount of power provided from each power control system. In this manner, an amount of power supplied by a whole power supply network may be controlled in an autonomous and decentralized manner. Note that each controller may control the power supplied by the power control system using information received from other power supply control systems in the network (e.g., capacity information). Similarly, synchronization circuitry of each of the plurality of power control systems may synchronize the AC signal provided by the power control system from each power source with the AC signal on the power bus. The synchronization circuitry may provide the synchronized AC signal on the power bus. In this manner, autonomous synchronization may be performed throughout the power supply network.

In some examples, synchronization circuitry may autonomously synchronize the AC signal from the power source and the AC signal from the power bus without external control. For example, the controller may use hardware and/or software to provide synchronization and/or control. In parallel or in series, the controller may collect capacity information from internal resources, such as one or more connected power sources, the inverter, the synchronization circuitry, and/or the charge controller, and from external resources (e.g., other power control systems) via the communication bus. The controller may control the amount of power from the corresponding power control system to the power bus. The plurality of power control systems in the network may accordingly autonomously control the amount of power to be supplied on the power bus and the synchronization across AC signals from the plurality of power control systems connected to the power bus.

A power supply network including multiple power control systems may also be referred to herein as a distributed intelligence management system. The power supply network may facilitate communication between power control systems and a load grid, parameterization and monitoring of each power control system coupled to a corresponding power source, and additional management. Power supply systems may give weights to different power systems and characteristics. The collection of power supply systems may be viewed as a distributed control layer that may provide infrastructure for a distributed artificial intelligence based power control system. Note that even extremely simple non-linear systems may produce irregularly powerful results by their complex and/or chaotic behaviors. Thus, such simple non-linear systems may become complex systems, such as an autonomous artificial intelligence electrical grid.

Other technical features may be apparent from the following figures, descriptions, and claims.

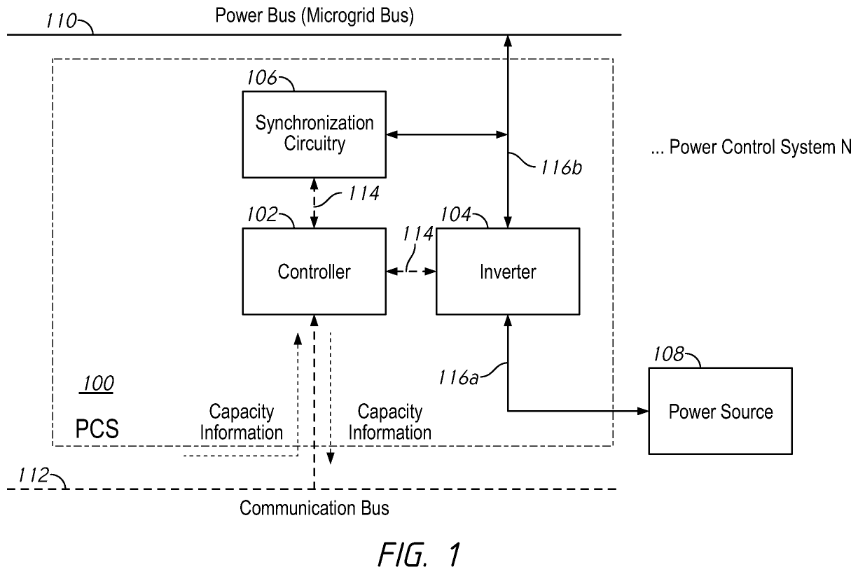

FIG. 1 is a schematic diagram of a power control system 100, arranged according to examples described herein. The power control system 100 includes a controller 102, an inverter 104, and synchronization circuitry 106. The power control system 100 is coupled to a power bus 110 and a communication bus 112. The power control system 100 is coupled to a power source 108. Additional power control systems (e.g., N power control systems) may also be coupled to the power bus 110 and/or communication bus 112.

The components shown in FIG. 1 are exemplary. Additional, fewer, and/or different components may be used in other examples.

Power control systems described herein, such as power control system 100 of FIG. 1 may be provided in an enclosure. For example, an enclosure may enclose controller 102, inverter 104, and/or synchronization circuitry 106. An output port may be provided for connection to one or more power sources, such as power source 108, and one or more buses or other communication interfaces, such as bus 110 and bus 112 of FIG. 1. In this manner, the power control system may be a part that may be modularly connected, disconnected, and/or reconnected from power sources and busses. This may advantageously allow power control systems described herein to be connected to legacy busses, interfaces, and/or power sources.

Examples of power control systems described herein may be coupled to one or more power sources. A single power source 108 is depicted in FIG. 1 coupled to the power control system 100, however any number of power sources may be present in other examples. Examples of power sources that may be used include, but are not limited to, solar photovoltaics, diesel generators, fuel cells, wind turbines, hydroelectric facility, bio-power sources, and/or ESSs.

In some examples, the power control system 100 may be coupled to a power source 108 via a power line, such as power line 116a of FIG. 1. The power line 116a may be implemented using one or more conductive traces, e.g., wires, in some examples. The power line 116a may be implemented using one or more transmission lines. The power line 116a may be a low voltage line, medium voltage line, high voltage line, extra high voltage line, and/or ultra high voltage line. The power control system 100 may receive power from the power source 108 via the power line 116a. In some examples, the power may be provided from the power source as a DC signal (e.g., a DC current or a DC voltage).

Examples of power control systems described herein may include one or more inverters, such as inverter 104 of FIG. 1. The inverter 104 is coupled to the power line 116a, and may receive power from the power source 108. In some examples, the inverter 104 may convert the DC signal from the power source into an AC signal (e.g., an AC current or an AC voltage). The output AC signal may have any of a variety of frequencies, such as 50 or 60 Hz in some examples. The AC signal may be a sine wave, square wave, modified sine wave, or other waveforms may be used. The AC signal may have any of a variety of magnitudes, including 120 and/or 240 V, for example. Any of a variety of power electronics may be used to implement inverter 104 and may include, for example one or more transformers and/or switches. In some cases, the inverter 104 may be paralleled or/and combined and configured to generate additional power at a nominal operating voltage of the inverter 104. Alternatively, in some cases, the inverter 104 may be separately configured to deliver 120V/240V operation. Alternatively, in some cases, the inverter 104 may be separately configured to generate modular and scalable three-phase power.

The AC signal may be provided to a power bus described herein, such as power bus 110 of FIG. 1. For example, the inverter 104 may be coupled to a power line 116b. The power line 116b may be implemented by one or more conductive traces, e.g., wires. The power line 116b may be implemented using one or more transmission lines. In some examples, the inverter 104 may provide the power (e.g., AC signal) to the power line 116b. The power provided to the power line 116b may be further provided to the power bus 110.

Power control systems described herein may accordingly be used to couple one or more power sources to a power bus, such as power bus 110 of FIG. 1. The power bus may also be referred to as a microgrid bus. The microgrid bus generally may be coupled to multiple power sources (e.g., a microgrid) through respective power control systems described herein. The microgrid bus may be implemented using one or more conductive traces (e.g., wires), transmission lines, busbars, or other conductive structures.

Examples of power control systems described herein may synchronize AC signals generated by an inverter with an AC signal present on a power bus. In this manner, a synchronized waveform may be provided to the power bus. Synchronization or synchronized generally refers to a phase of the AC signal output from the inverter being the same as a phase of the AC signal present on the power bus. By synchronizing the signals, the power provided by the power control systems described herein may be effectively considered added to one another at the power bus. Without synchronization, the power signals from multiple power control systems may not as efficiently sum together at the power bus to supply an overall power amount.

Accordingly, examples of power control systems described herein may include synchronization circuitry, such as synchronization circuitry 106 of FIG. 1. The synchronization circuitry 106 may be coupled to the inverter 104 through the power line 116b. In some examples, the synchronization circuitry 106 may synchronize the AC signal from the inverter 104 with another AC signal on the power bus 110. Each power control system in a network may provide similar synchronization for the AC signals provided by the respective power control systems. In this manner, autonomous synchronization of power sources may be provided. In some examples, the synchronization circuitry 106 may include a non-linear circuit or a chaotic circuit which may be coupled via reference connections to a grid. Such synchronization circuitry 106 may include, for example, non-linear elements, locally active resistors and energy storage components to create a non-linear chaotic system as described herein. However, the non-linear circuit or a chaotic circuit may be implemented through a variety of designs and physical components. In some examples, AC signal synchronization may be performed at least in part, using software controls, such as instructions stored in the controller 102 or the synchronization circuitry 106. In some examples, the synchronization circuitry 106 may be integrated into the inverter 104 which may synchronize the AC signal to an AC signal from another inverter coupled to another power source or an AC signal to a power grid system providing the synchronized power signal to a load. In some examples, the synchronization circuitry 106 may be integrated into a variety of other controllers with either having exclusive functionality to synchronize AC signals, or another ability to do so packaged with a variety of other features. In some examples, the controller 102 may receive synchronization status information indicative of whether the synchronization circuitry 106 is performing the synchronization of AC signals from the synchronization circuitry 106 to the AC signal on the power bus 110. The controller 102 may provide the synchronization status information on the communication bus 112.

In some examples, the controller 102 may monitor a status of the power source 108. The controller 102 may collect information regarding operation of the power source 108 (e.g., capacity information). In some examples, some capacity information, which may also be referred to as state information, may be stored in a memory or other computer readable storage medium in communication with the controller 102. The controller 102 may be provided status information from the inverter 104 and/or the synchronization circuitry 106. In some examples, the controller 102 may be coupled to the inverter 104 and the synchronization circuitry 106 through the control lines 114. The control lines 114 may be implemented as conductive traces (e.g., wires and/or a bus). Examples of status information (e.g., capacity information) which may be accessible to and/or provided to the controller 102 includes a present location of the power source 108, a present time, and other capacity information of the power source 108, such as maximum and minimum capacity of the power source 108. In some examples, the capacity information may include a remaining capacity of local energy storage coupled to the power source, as described herein. Accordingly, capacity information that may be available to the controller 102 includes time, location, present power output from the power source, maximum available power from the power source, minimum available power from the power source, and/or cost (e.g., economic cost) of power from the power source. Note that capacity information may change over time. The present power output from the power source, and/or remaining capacity of local storage may change over time, for example. The cost of the power from the power source may also vary over time. Controller 102 may be provided with updated capacity information over time from the power source, synchronization circuitry, and/or inverter.

In some examples, the power control system 100 may be coupled to a communication bus 112. The communication bus 112 may be implemented using conductive traces (e.g., wires). While depicted as a bus, in some examples, the communication bus may be implemented using a wireless interface (e.g., Wi-Fi or other wireless communication may be used). In some examples, the controller 102 may be coupled to the communication bus 112 and may exchange information about the power source 108 with another controller in another power control system via the communication bus 112. In some examples, the controller may provide capacity information associated with the power source 108 to the communication bus 112, and receive capacity information associated with one or more power sources from one or more controllers of one or more power control systems via the communication bus 112.

In some embodiments, the controller 102 may utilize the capacity information of the power control system 100, as well as the capacity information of other power control systems in the network, to provide power to the power bus 110. The timing and manner of providing an AC signal from a power source of the power control system 100 to the power bus 110 may be based on a collection of capacity information, In some examples, the controller 102 may control the inverter 104 and the synchronization circuitry 106 to control an amount of power of the AC signal to the power bus 110 based on the capacity information associated with the power source 108 and the other capacity information associated with one or more power sources. In some examples, the controller 102 and the one or more controllers may determine an amount and timing of power to be supplied as the AC signal to the power bus 110.

In some embodiments, the controller 102 may control the amount of power, at least in part by evaluating a cost function. The controller 102 may select an amount and/or timing of power delivery from a connected power source that causes a cost function or other cost metric to meet one or more criteria. For example, the controller 102 may select an amount of power delivery that maximizes and/or minimizes a cost function. In some examples, the controller 102 may be implemented as a processor and a computer-readable storage medium storing executable instructions for the processor (e.g., software and/or firmware). In some examples, the computer-readable storage medium may store executable instructions to cause the controller 102 to perform operations described herein, including to provide internal control, internal and external communications and cost function evaluations. The computer readable medium (or another storage medium in communication with the controller) may store data, such as one or more parameters, such as capacity information described herein, and/or the cost function. The stored capacity information may include capacity information of multiple power control systems in a network. For example, the instructions, when executed by the controller, may cause the controller 102 to receive capacity information from at least one of the inverter 104 and the synchronization circuitry 106, and store the capacity information in a portion of the computer-readable storage medium. Stored instructions may cause the controller to provide a communication bus 112 with capacity information, receive the other capacity information from the communication bus 112. Stored instructions may cause the controller to evaluate a cost function using the stored capacity information, and control the amount of power to the power bus 110 based on the cost function evaluation.

In some examples, the capacity information of the power source 108 may include at least one of a location or time of the power source 108, maximum power output from the power source 108, or minimum power output from the power source 108. In some examples, the controller 102 may receive demand information of loads that may receive power via the power bus 110, and the controller 102 may control the amount of power further based on the demand information. In some examples, the instructions further cause the controller 102 to compute the cost function based on the capacity information and the other capacity information, and control the amount of power based on the cost function. In some examples, the instructions further cause the controller 102 to receive demand information about at least one load via the communication bus, and compute the cost function based on the demand information. In some examples, the demand information may be a total demand amount by loads coupled to the power bus 110. The cost function may be based on the location or time of the first power source, the maximum power output from the first power source, the minimum power output from the first power source, time of a day, demand information, etc. Regardless of a type of power source, for example, solar PV, a diesel generator, a fuel cell, a wind turbine, a hydroelectric facility, a bio-power source, an ESS, or any combination thereof, using the cost function, the controller 102 may control the amount to provide on the power bus 110.

In some examples, the power control system 100 may also include a power line coupled to the inverter and the synchronization circuitry. The inverter may receive a DC signal (e.g., DC current or DC voltage) from the power source, to convert the DC signal into the AC signal (e.g., AC current or AC voltage), and further provide the AC signal to the power line. The synchronization circuitry coupled to the power line may receive the AC signal from the power line and synchronize the AC signal with the other AC signal on the power bus.

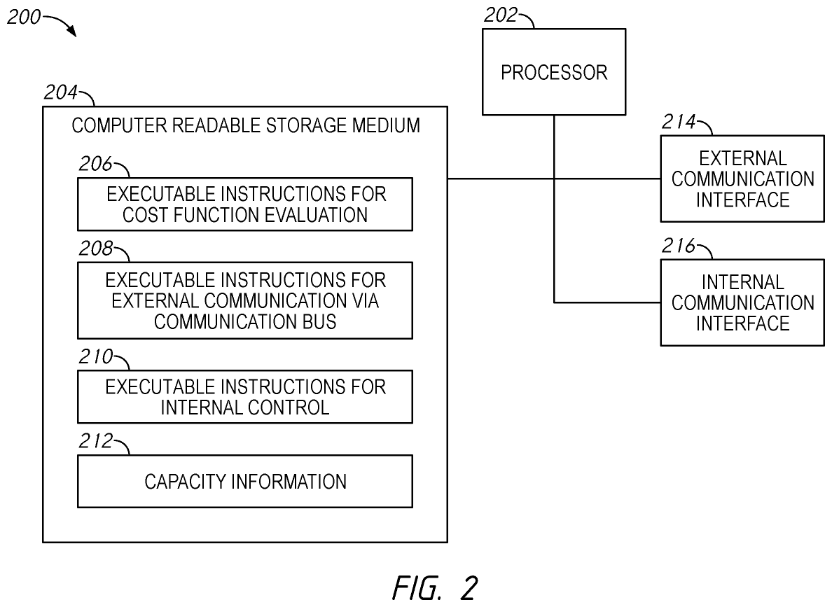

FIG. 2 is a schematic diagram of a controller 200, according to examples described herein. In some examples, the controller 200 may be the controller 102 in FIG. 1. In some embodiments, the controller 200 may be implemented as a microprocessor or a microcontroller. In some examples, the controller 200 may include a processor 202 and a computer-readable storage medium 204. The computer-readable storage medium 204 may store executable instructions and data. The computer-readable storage medium 204 includes a non-transitory computer-readable storage medium that may store executable instructions. For example, the executable instructions may include executable instructions for cost function evaluation 206, executable instructions for external communication via communication bus 208, and executable instructions for internal control 210. The data may include capacity information 212. In some examples, the controller 200 may include an external communication interface 214 and an internal communication interface 216. The external communication interface 214 and the internal communication interface 216 may include hardware to perform transmission and reception of control signals and data signals, controlled by the executable instructions for external communication via communication bus 208 and the executable instructions for internal control 210, respectively.

In some embodiments, the internal communication interface 216 may handle communications on a control line, including control signal transmission to circuits and data collection from circuits in a power control system, such as the power control system 100. The executable instructions for internal control 210 may cause the internal communication interface 216 of the controller 200 to perform internal control of power circuits, such as an inverter (e.g., the inverter 104), synchronization circuitry (e.g., the synchronization circuitry 106), and switches (e.g., breakers). The executable instructions for internal control 210 may cause the controller 200 to perform internal communications to receive information related to evaluation of cost function, including capacity information from at least one of the inverter and the synchronization circuitry and store the capacity information in a portion of the computer-readable storage medium 204, such as data storage for the capacity information 212.

In some examples, the external communication interface 214 may handle communication on a communication bus (e.g., the communication bus 112 of FIG. 1) including exchange of capacity information between power control systems. The executable instructions for external communication via communication bus 208 may cause the external communication interface 214 of the controller 200, to perform transmission and reception of capacity information via the communication bus. For example, the executable instructions for external communication via communication bus 208 may cause the controller 200 to provide a communication bus with capacity information, and to receive the other capacity information from the communication bus. The executable instructions for external communication via communication bus 208 may further cause the controller 200 to store the received capacity information in the portion of the computer-readable storage medium 204, such as data storage for the capacity information 212.

In some examples, capacity information may include at least one of a location or time of a power source, maximum power output from the power source, minimum power output from the power source, present power output, and/or and storage capacity. In some examples, the controller 200 may receive demand information.

In some embodiments, the executable instructions for cost function evaluation 206 may cause the controller 200 to evaluate a cost function based on the capacity information obtained internally and through the communication bus stored in the data storage for capacity information 212. In some examples, the cost function evaluation may further be based on the demand information of loads receiving power. The executable instructions for internal control 210 may cause the controller 200 to control the amount of power by controlling the inverter and the synchronization circuitry using the internal communication interface 216, based on the cost function. The cost function may be based on the location or time of the first power source, the maximum power output from the first power source, the minimum power output from the first power source, time of a day, demand information, present operating power, power constraint limits (e.g., minimum power and maximum power), available storage energy, state-of-charge, state-of-charge limits, etc. Regardless of a type of power source, for example, solar PV, a diesel generator, a fuel cell, a wind turbine, a hydroelectric facility, a bio-power source, an ESS, or any combination thereof, using the executable instructions for cost function evaluation 206, controllers in a power supply network system may control the amounts of power to provide on the power bus.

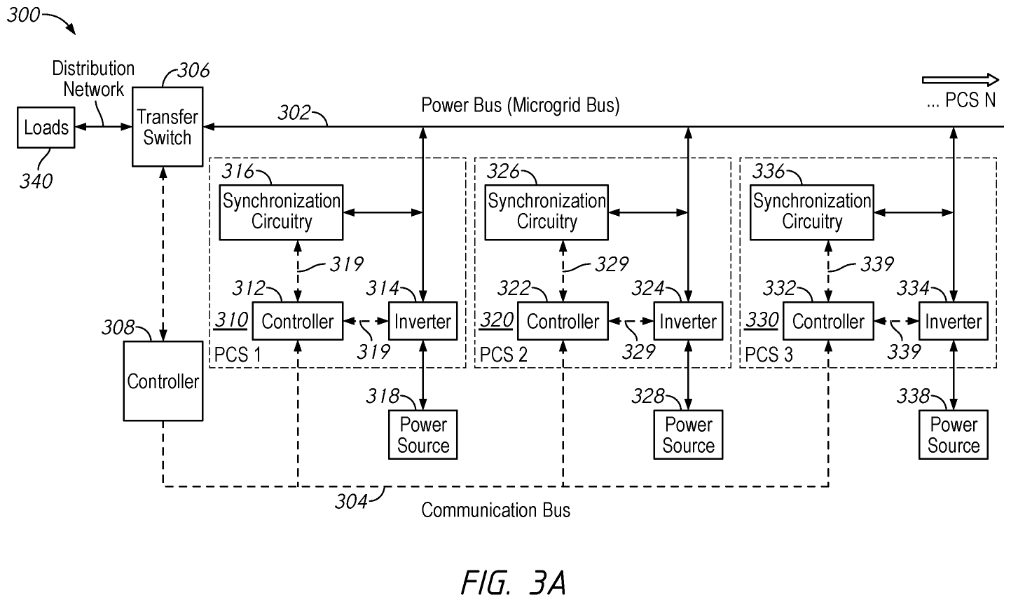

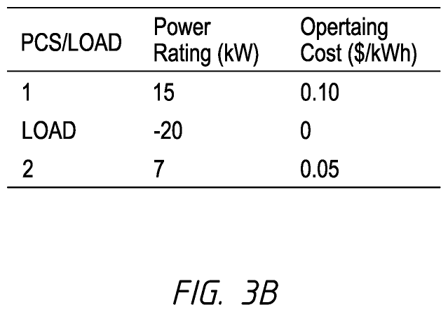

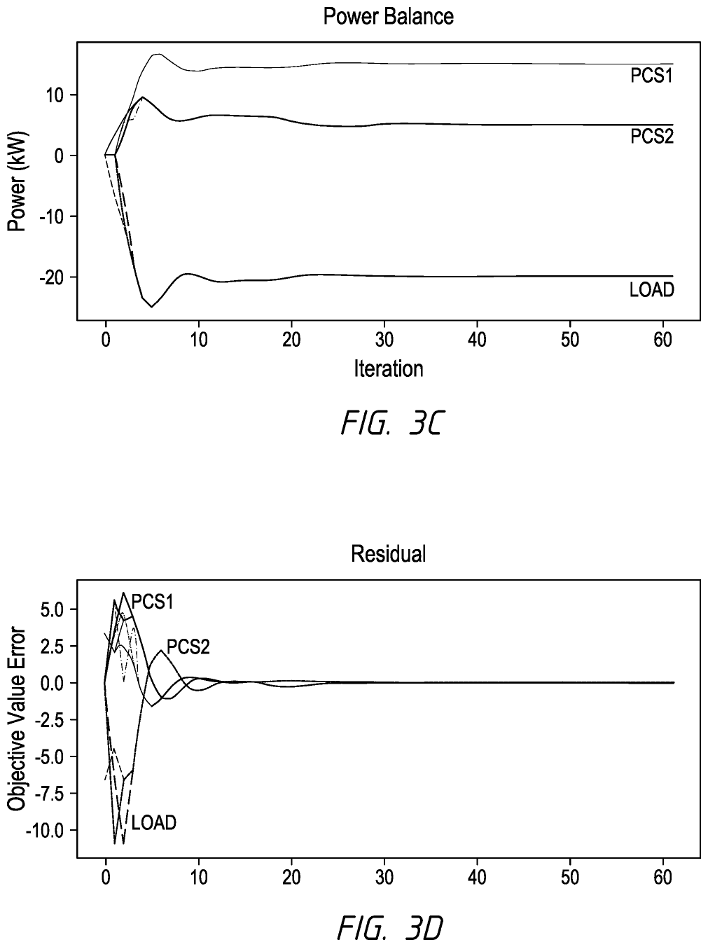

FIG. 3A is a schematic diagram of a power supply network system 300, according to examples described herein. The power supply network system 300 includes a plurality of power control systems. In some examples, the power supply network system 300 may include the power control system 100 of FIG. 1. The power supply network system 300 includes power control systems 310, 320, 330 coupled to power sources 318, 328, 338, respectively. The power supply network system 300 may also include a power bus 302 and a communication bus 304 throughout the power supply network system 300. In some examples, the power bus 302 and the communication bus 304 may be the power bus 110 and the communication bus 112 of FIG. 1, respectively. The power supply networks system 300 described herein may include the power bus 302 and the communication bus 304 to provide power delivery and communications respectively. In some examples, the power bus 302 and the communication bus 304 may be integrated to further provide power delivery and communications. In some examples, each power control system in the power supply network system 300 may include an inverter, such as the inverter 104 of FIG. 1, that receives power from a power source and provides an AC signal to the power bus 110. In some examples, the power control systems 310, 320, 330 may include inverters 314, 324, 334, respectively. Each of the power control systems 310, 320, 330 also includes synchronization circuitry, such as the synchronization circuitry 106 of FIG. 1, coupled to the power bus that synchronizes the AC signal with at least another AC signal on the power bus 302. In some examples, the power control systems 310, 320, 330 may include synchronization circuitry 316, 326, 336, respectively. Each of the power control systems 310, 320, 330 includes a controller, such as the controller 102 of FIG. 1 and/or the controller 200 of FIG. 2. In some examples, the power control systems 310, 320, 330 may include controllers 312, 322, 332, respectively. In some examples, the controllers 312, 322, 332 may be coupled to the inverters 314, 324, 334 and the synchronization circuitry 316, 326, 336 through the control lines 319, 329, 339, respectively. Detailed description of structures and functionalities of the power control systems 310, 320, 330 and components therein that have been previously described referring to the power control system 100 is therefore not repeated herein for brevity.

In some embodiments, the power control systems 310, 320, 330 may perform software-based control of the amount of power to be supplied on the power bus 302. In some examples, the controllers 312, 322, 332, may control the amounts of power, at least in part by evaluating a cost function. In some examples, the cost function may be evaluated using parameters, such as capacity information. In some examples, the capacity information may include at least one of a location or time of corresponding power source, maximum power output from the first power source, or minimum power output from the corresponding power source. The controllers 312, 322, 332 may provide capacity information associated with the power sources 318, 328, 338 to the communication bus 304, receive other capacity information associated with the other power sources from the communication bus 304, and control an amount of power to the power bus 302 based on the capacity information from power sources coupled to the power bus 302, including the power sources 318, 328, 338.

In some examples, the controllers 312, 322, 332 may receive demand information, and control the amount of power further based on the demand information. The power supply network system 300 may be coupled to a distribution network including loads 340, a transfer switch 306 coupled to the loads and further coupled to the power bus 302. The distribution network may also include a controller 308 coupled to the transfer switch 306 and further coupled to the communication bus 304. The controller 308 may obtain the demand information either directly from the loads or through the transfer switch 306, and provide the demand information to the controllers 312, 322, 332 via the communication bus 304. The transfer switch 306 may allow the power from the power supply network system 300 on the power bus 302 to be provided in the distribution network if the AC signals from the plurality of power control systems in the power supply network system 300 are synchronized to the AC signal on the power bus 302. The transfer switch 306 may be turned off responsive to control by the controller 308 while any of the AC signal is not yet synchronized. Alternatively or additionally, the transfer switch 306 may automatically disconnect the power supply network system 300 from the distribution network in the case of a fault. For example, each of the controllers 312, 322, 332 may receive synchronization status information indicative of whether any of the synchronization circuitry 316, 326, 336 is performing the synchronization of AC signals from any of the inverters 314, 324, 334 to the AC signal on the power bus 302. The controllers 312, 322, 332 may provide the synchronization status information to the controller 308 coupled to the transfer switch 306. The controller 308 may turn on or off the transfer switch 306 based on the synchronization status information from the controllers in the power supply network system 300. The transfer switch 306 may include, but is not limited to, a manual breaker, an automatic transfer switch, a computer-controlled breaker, and any method or device by which the transfer switch 306 may connect, disconnect, or reconnect responsive to, at least in part by, control of the controller 308 or fault detection. As described herein, each controller of each of the plurality of power control systems may control the amount of power from each power control system using the capacity information and the demand information, thus a total amount of power supplied by the power supply network system 300 may be controlled in an autonomous and decentralized manner. Each synchronization circuitry of each of the plurality of power control systems in the power supply network system 300 synchronizes each AC signal representing power from each power source with the other AC signal on the power bus 302 and provides the synchronized AC signal on the power bus 302, thus autonomous synchronization may be performed throughout the power supply network system 300.

FIG. 3B-3D depict a simulation of a network system described herein including two power control systems (e.g., two power control nodes) and a load.

FIG. 3B is a table of simulation conditions of power control systems of a power supply network system, according to examples described herein. FIG. 3B describes two power control systems (PCS #1 310, and PCS #2 320) and a load 340. Those PCS components may be included in a system described herein, such as the system of FIG. 1. For example, any of the PCS components described in FIG. 3B may be implemented by, or used to implement, the PCS 100 of FIG. 1. In the example of FIG. 3B, PCS #1 310 has a power rating of 15 kW as a power supply and an operating cost of $0.10/kWh. The load 340 has a power rating of −20 kW, meaning demanding power of 20 kW. PCS #2 320 has a power rating of 7 kW as a power supply and an operating cost of $0.05/kWh. The power rating and operating cost information may be provided by one PCS to other PCSs in the system as capacity information described herein, in some examples. For example, the PCS #1 may communicate the power rating and operating cost to PCS #2 in the example of FIG. 3B (it may also communicate capacity information to the load 340 in some examples). PCS #1 may receive the power rating and operating cost shown of PCS #2 (it may also receive demand information from the load 340, in some examples). The information may be used by each PCS to determine how much power to provide as output to a power bus in some examples.

FIG. 3C is a diagram of a power balance among the power control systems of the power supply network system, according to examples described herein. Generally, the two PCSs described with reference to FIG. 3B may exchange capacity information, and evaluate a cost function, such as to determine a least cost operation across the two PCS units 310 and 320 to deliver power satisfying demand of the load 340 to the power bus. The graph of FIG. 3B illustrates a power (kW) output by each of PCSs #1, and #2, and a power input for the load 340 of FIG. 3B across multiple iterations of communication between the units. Generally, the system may evaluate a cost function or metric to achieve one or more particular criteria. For example, the system may aim to minimize an overall cost of power delivery to the load 340. In a first iteration, capacity information may be received from the other units in the system, and each PCS may determine a power to provide, such as by identifying a least cost solution for the system. Then, updated capacity information may be shared among the PCS units, and each PCS unit may again determine an amount of power to provide based on the updated capacity information. This may be referred to as a second iteration. Over time (around 55 communication iterations in the example of FIG. 3C), a power sharing consensus may be achieved where each PCS is providing a particular amount of power. In the example of FIG. 3C, the PCS #2 320 having a lower operation cost may provide its full power (7 kW) and the PCS #1 310 having a higher operation cost may provide the rest of power demanded (13 kW) among its full capacity (15 kW) to meet the demand of the load 340 (20 kW) once the consensus is achieved. Thus, the entire cost to provide the power demanded by the load 340 may be minimized in the example of FIGS. 3A-3C.

FIG. 3D is a diagram of residuals of the power control systems of the example power supply network system, according to examples described herein. FIG. 3D illustrates a value of an error across each iteration shown in FIG. 3C. Generally, there may be an error between the existing metric and an optimal metric. The error for each iteration is shown in FIG. 3D for the example of FIG. 3C. As can be seen, the error may be larger during early iterations when a consensus may not have been achieved. However, the error may be reduced, and may become zero as a consensus is achieved among the PCSs. The error may represent a departure from equilibrium power delivery. As shown in FIG. 3D, this residual may go to zero after approximately 45 iterations, indicating that the overall system has achieved a balanced and shared power delivery from two sources (e.g., 310 and 320) to the load 340. The source power is larger than zero, and the load power being consumed is less than zero.

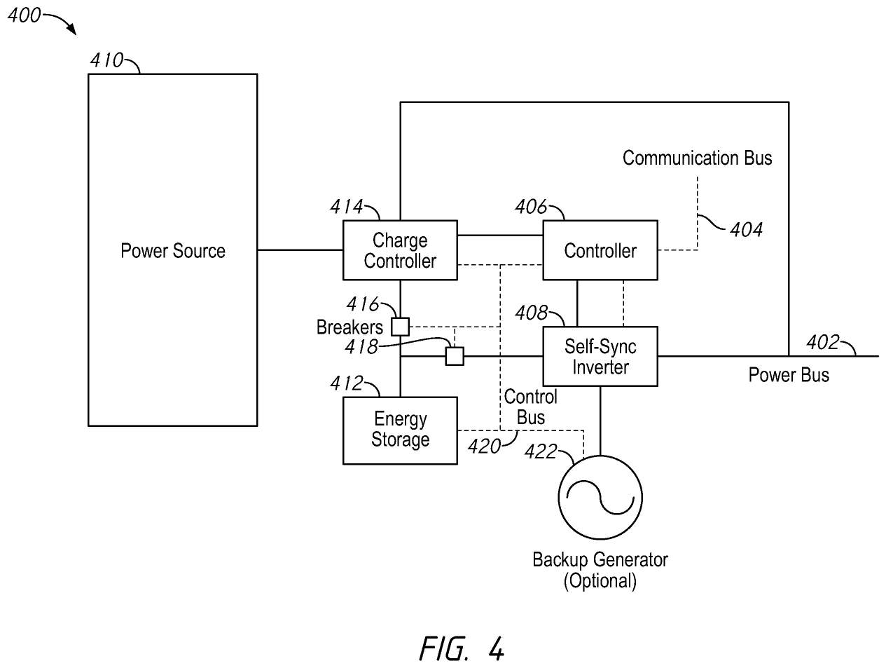

FIG. 4 is a schematic diagram of a power control system 400, according to examples described herein. The power control system 400 may include a controller 406, a self-synchronizing inverter 408, a charge controller 414, and breakers 416 and 418. The power control system 400 may further include a generator 422 and energy storage 412. The power control system 400 may also include a control bus 420 that allows communication of control information between the controller 406 and the components of the power control system 400. The self-synchronizing inverter 408 may be coupled to a power bus 402, and the controller 406 may be coupled to a communication bus 404. In some examples, the controller 406 may include the controller 102 of FIG. 1 and/or the controller 200 of FIG. 2, and the communication bus 404 may be the communication bus 112. Detailed description of structures and functionalities of the controller 406 and the communication bus 404 and components therein that have been previously described referring to the controller 102 and the communication bus 112 is therefore not repeated herein for brevity.

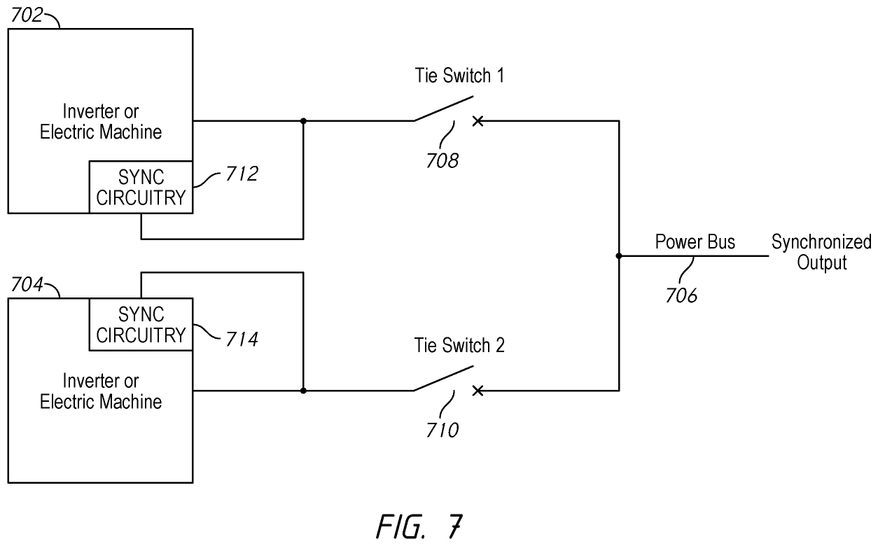

In some embodiments, the self-synchronizing inverter 408 integrates functionality of the inverter 104 and the synchronization circuitry 106. In some examples, self-synchronizing inverter 408 may perform conversion of a DC signal from a power source 410 to an AC signal and synchronization of the voltage and frequency of the AC signal with an AC signal on the power bus 402. In some examples, the self-synchronizing inverter 408 may include the inverter 104 that incorporates the synchronization circuitry, such as synchronization circuitry 106 of FIG. 1. However, the self-synchronizing inverter 408 may be arranged in a variety of ways. Examples in FIGS. 7-11 illustrate and support further disclosure of a system including a plurality of self-synchronizing inverters. However, the exact arrangement of the example provided is not indicative of the only arrangement the self-synchronizing inverter 408 may embody. The power control system 400 including the self-synchronizing inverter 408 may allow a plurality of power control systems 400 to be stacked and replicated independent from a type of the power source 410 (e.g., distributed energy resource (DER)) in each power control system 400 (e.g., microgrid). The power control system 400 in FIG. 4 is just one example layout of a power control system deployed in a power supply network system.

In some embodiments, the power control system 400 may further include the charge controller 414 coupled to the energy storage 412, that controls an amount of power to store in the energy storage 412 based on the amount of power to the power bus 402 and the capacity information. In some examples, the controller 414 may monitor status of components in the power control system 400 and log the status of the components, including a synchronization status of an AC signal, and parameters relevant to capacity information. In some examples, the controller 406 may include the charge controller 414. The controller 406 may collect capacity information further including power storage capacity of the energy storage 412 in addition to capacity information associated with the power source 410. In some examples, the energy storage 412 may include at least one of a battery, a flywheel, a pumped hydroelectric system, a standard hydroelectric system, compressed gas storage, or any combination thereof. In some examples, the charge controller 414 manages a flow of energy, such as for properly controlling the energy storage 412 (e.g., a battery charge/discharge process) as well as monitoring general power flow from the power source 410. In some examples, the charge controller 414 may include an input for receiving power from the power source 410. The input of the charge controller 414 may receive either AC signal or DC signal. The charge controller 414 may regulate the power from the power source 410 or otherwise limit the rate at which the DC signal is added to or drawn from the energy storage 412. The charge controller 414 may protect against overcharging or overvoltage, which can reduce the performance or lifespan of the energy storage 412 and may also protect against deep discharging (or draining) of the energy storage 412. The charge controller 414 may also perform controlled discharges, depending on the technology of the energy storage 412, to protect the performance and/or lifespan of the energy storage 412. The energy storage 412 may serve as a DC link. Along with controller 406, the power flow from the power source 410 may be easily managed and monitored.

The breakers 416 and 418 may provide protection to subsystems of the power control system 400, such as the energy storage 412 in the event of a fault or abnormal condition. The breakers 416 and 418 may be designed to act independently of control in the case of some faults. In some examples, the breakers 416 and 418 may be easily designed to open for abnormal over-current conditions without need of a controller. In some examples, the charge controller 414 or the controller 406 may control the breakers 416 and 418 by sending control signals on the control bus 420. For example, the charge controller 414 or the controller 406 may control the breaker 416 between the charge controller 414 and a node coupled to the energy storage 412 and the self-synchronizing inverter 408 to control connection and disconnection from the charge controller 414 to provide power from the power source 410. In some examples, the charge controller 414 or the controller 406 may control the breaker 418 between the energy storage 412 and the self-synchronizing inverter 408 to control an amount of power to be converted into AC signal and synchronized to be provided on the power bus 402 or to stop converting at least some of the DC signal to be provided to the self-synchronizing inverter 408 while providing the DC signal directly from the controller 406. In some examples, the controller 406 may directly control the charge controller 414 and the self-synchronizing inverter 408 to control the amount of power. In any case, the controller 406, solely or together with the charge controller 414, may control the amount of power, including controlling the self-synchronizing inverter 408 to adjust an amount of power, and control the charge controller 414 to adjust an amount of power to store in the energy storage 412.

The power control system 400 may include the generator 422 that may convert mechanical energy to electrical energy. In some examples, the self-synchronizing inverter 408 may further synchronize an AC signal from the generator 422 with the AC signal on the power bus 402, and provide the synchronized AC signal to the power bus 402.

The controller 406 may collect capacity information from internal resources, such as the self-synchronizing inverter 408, or the charge controller 414, and from external resources via the communication bus 404, and control the amount of power from the power control system 400 to the power bus 402 while controlling the amount of power to store in the energy storage 412. Thus, a plurality of power control systems in a power supply network system including the power control system 400 may autonomously control the amount of power to be supplied on the power bus 402 and the synchronization across AC signals from the plurality of power control systems on the power bus 402.

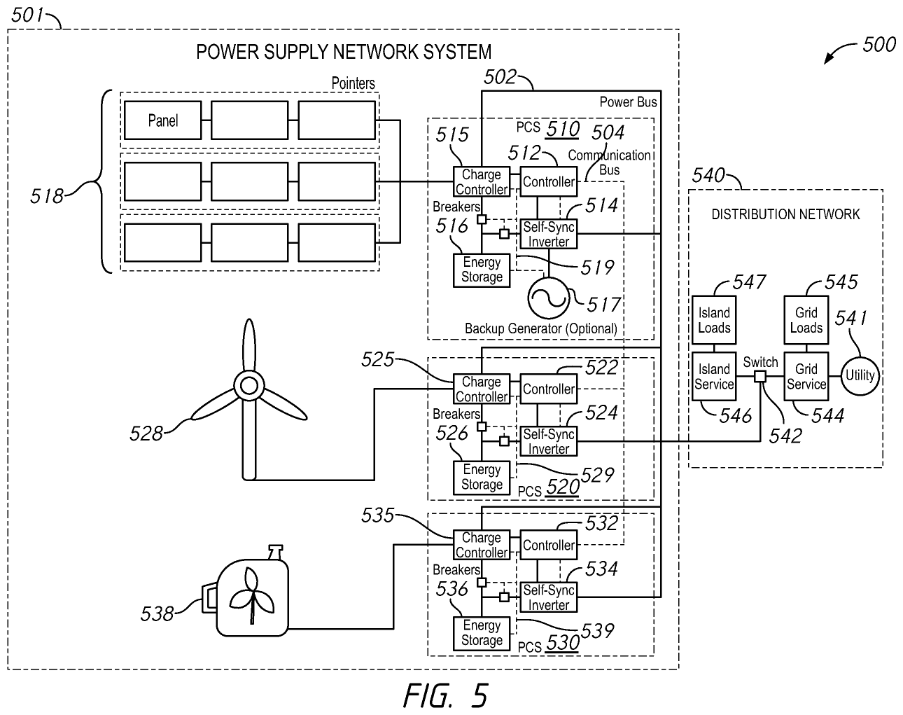

FIG. 5 is a schematic diagram of a power grid system 500, according to examples described herein. The power grid system 500 may be a modular microgrid system, including a power supply network system 501 and a distribution network 540 coupled to one another by at least a power bus 502.

The power supply network system 501 includes a plurality of power control systems. In some examples, the power supply network system 501 may include the power control system 100 of FIG. 1. The power supply network system 501 includes power control systems 510, 520, 530, coupled to power sources 518, 528, 538, respectively. The power supply network system 501 may also include the power bus 502 and a communication bus 504 throughout the power supply network system 501. In some examples, the power bus 502 and the communication bus 504 may be the power bus 402 and the communication bus 404 of FIG. 4, respectively. Each of the power control systems 510, 520, 530 includes a controller, such as the controller 406 of FIG. 4 and/or the controller 200 of FIG. 2. In some examples, the power control systems 510, 520, 530 may include controllers 512, 522, 532. Each of the power control systems 510, 520, 530 may include energy storage and a charge controller, such as the energy storage 412 and the charge controller 414 of FIG. 4. In some examples, the power control systems 510, 520, 530 may include energy storages 516, 526, 536 and charge controllers 515, 525, 535 coupled to the energy storages 516, 526, 536, respectively. The components in the power control systems 510, 520, 530 may be controlled using control buses 519, 529, 539, respectively. Some of the power controls systems in the power supply network system 501, such as the power control system 510, may include a backup generator 517, such as the generator 422 of FIG. 4. As described herein, detailed description of structures and functionalities of the power control systems 510, 520, 530 and components therein that have been previously described referring to the power control system 400 is not repeated herein for brevity.

In some embodiments, the power control systems 510, 520, 530 may perform software-based control of the amount of power to be supplied on the power bus 502. In some examples, the controllers 512, 522, 532 may control the amounts of power, at least in part by evaluating a cost function. In some examples, the cost function may be evaluated using parameters, such as capacity information. In some examples, the capacity information may include at least one of a location or time of corresponding power source, maximum power output from the first power source, or minimum power output from the corresponding power source. The controllers 512, 522, 532 may provide capacity information associated with the power sources 518, 528, 538 to the communication bus 504, receive other capacity information associated with the other power sources from the communication bus 504, and control an amount of power to the power bus 502 based on the capacity information from power sources coupled to the power bus 502, including the power sources 518, 528, 538.

In some examples, the power sources 518, 528, 538, coupled to the power control systems 510, 520, 530 may be any type of power source, for example, solar PV, a diesel generator, a fuel cell, a wind turbine, a hydroelectric facility, a bio-power source, an ESS, or any combination thereof. The power control systems 510, 520, 530 may be designed to function regardless of the type of power resource. In this example of FIG. 5, the power sources 518, 528, 538 may be solar PV, a wind turbine, and a bio-power source, for example. Each controller may store capacity information for each corresponding power source.

In some examples, each power control system in the power supply network system 501 includes a self-synchronizing inverter, such as the self-synchronizing inverter 408 of FIG. 4, that receives power from a power source. After synchronizing the received power with an AC signal on the power bus 502, the self-synchronizing inverter provides the synchronized AC signal to the power bus 502. In some examples, the power control systems 510, 520, 530 may include self-synchronizing inverters 514, 524, 534, respectively. The self-synchronizing inverters 514, 524, 534 autonomously synchronize their respective AC signals based on the power from the power sources 518, 528, 538 without external control. Using the self-synchronization, hot-swapping of any power control system coupled to any power source may be performed without forcing the power grid system 500 to shut down when any power control system is added to or removed from the power supply network system 501. Accordingly, scalability of power supply in any AC power system, such as the power grid system 500, may be accomplished in a seamless and dynamic manner. The self-synchronizing technology is not limited to three power sources as shown in FIG. 5. Using the self-synchronizing technology, an arbitrary number of sources may self-synchronize, that reduces the limitations of traditional methods of synchronization and autonomous operation and/or power sharing may be performed with additional resilience. Additionally, the other electronic components and energy storage could be arranged in any variety of ways that are commonly accepted in the renewable and microgrid development industries.

The power bus 502 may provide power from the power supply network system 501 to the distribution network 540. The distribution network 540 may include a transfer switch 542 that transfers or stops transferring the power from the power bus 502 to the distribution network 540. The distribution network 540 may further include, for example, a grid service 544 that is coupled to one or more grid loads 545, and an island service 546 that is coupled to one or more island loads 547. The grid service 544 may also be coupled to a utility 541. The power supply network system 501 may provide power to multiple loads, such as the grid loads 545 and island loads 547 from the power bus 502. The transfer switch 542 may allow the power from the power supply network system 501 on the power bus 502 to be provided in the distribution network 540 if the AC signals from the plurality of power control systems in the power supply network system 501 are synchronized to the AC signal on the power bus 502. The distribution network 540 may also include a controller (not shown) coupled to the transfer switch 542 and further coupled to the communication bus 504. The transfer switch 542 may be turned off responsive to control by the controller if any of the AC signals is not yet synchronized. Alternatively or additionally, the transfer switch 542 may automatically disconnect the power supply network system 501 from the distribution network 540 in the case of a fault. For example, each of the controllers 512, 522, 532 may receive synchronization status information indicative of whether the self-synchronizing inverters 514, 524, 534 are performing the synchronization of AC signals converted from DC signals from the power sources 518, 528, 538 to the AC signal on the power bus 502. The controllers 512, 522, 532 may provide the synchronization status information to the transfer switch 542. The transfer switch 542 may turn on or off based on the synchronization status information from the controllers in the power supply network system 501. The transfer switch 542 may include, but are not limited to, a manual breaker, an automatic transfer switch, a computer-controlled breaker, and any method or device by which the switch 542 may connect, disconnect and reconnect responsive to control or fault detection.

In some examples, the controllers 512, 522, 532 may receive demand information, and control the amount of power further based on the demand information from the multiple loads. The power supply network system 501 may be coupled to the transfer switch 542 of the distribution network 540 via the power bus 502. The distribution network 540 may include multiple loads, including grid loads 545 and island loads 547. The transfer switch 542 may be coupled to the loads. The distribution network 540 may also include a controller (not shown) coupled to the transfer switch 542 and further coupled to the communication bus 504. The controllers 512, 522, 532 may obtain the demand information either directly from the loads or through the transfer switch 542, and via the communication bus 504.

As described herein, each controller of each of the plurality of power control systems may control the amount of power from each power control system using the capacity information and the demand information, thus a total amount of power supplied by the power supply network system 501 may be controlled in an autonomous and decentralized manner. Each self-synchronizing inverter 514, 524, 534 of each of the plurality of power control systems 510, 520, 530 in the power supply network system 501 synchronizes each AC signal representing power from each power source with the other AC signal on the power bus 502 and provide the synchronized AC signal on the power bus 502, thus, autonomous synchronization may be performed throughout the power supply network system 501.

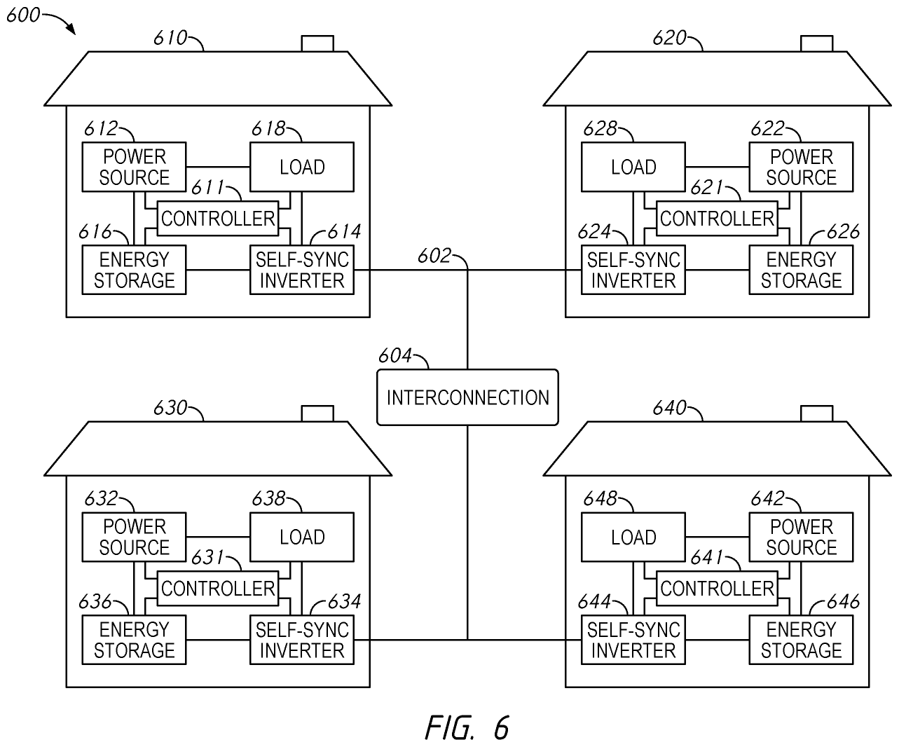

FIG. 6 is a schematic diagram of a power grid system 600, according to examples described herein. In some examples, power sources and loads are not separated into a power supply network system and a distribution network. The power grid system 600 may include subsystems including subsystems 610, 620, 630, 640. In some examples, each of the subsystems 610, 620, 630, 640 may be a nanogrid (e.g., a home grid, a building grid, a facility grid, a factory grid, a campus grid, etc.). The subsystems 610, 620, 630, 640 may include power sources 612, 622, 632, 642. In some examples, the power sources 612, 622, 632, 642 may be solar PV, a diesel generator, a fuel cell, a wind turbine, a hydroelectric facility, a bio-power source, an ESS, or any combination thereof. The subsystems 610, 620, 630, 640 may include self-synchronizing inverters 614, 624, 634, 644. The self-synchronizing inverters 614, 624, 634, 644 may convert DC signals from the power sources 612, 622, 632, 642 to AC signals and self-synchronize to an AC signal on a power bus 602. The power bus 602 coupled to subsystems 610, 620, 630, 640 may provide interconnection 604 among the subsystems 610, 620, 630, 640. The subsystems 610, 620, 630, 640 may include loads 618, 628, 638, 648, respectively. The subsystems 610, 620, 630, 640 may include energy storages 616, 626, 636, 646, respectively. When an amount of power demanded from a load in a subsystem is greater than an amount of power provided by a power source and energy storage within the subsystem, the power subsystem may receive more power from the other power subsystems in the power grid system 600. When the amount of the power demanded from the load in the subsystem is less than the amount of the power provided by the power source and the energy storage within the subsystem, the excess amount of power may be stored in the energy storage, or may be provided to the power bus 602 to be used by any of the other subsystems. Thus, the power grid system 600 may autonomously perform cooperative and complex system behavior, inspired by natural cooperative complex systems such as biological ecosystems. Because the power grid system 600 has flexibility to add a subsystem without modification to its synchronization scheme, the power grid system 600 is diverse, resilient, versatile, highly scalable and built to evolve and adapt. The implication for electrical grid application is significant improvement in sustainability, cost, resilience, and access. Along with the standard function of an inverter in a nanogrid, converting DC signal to AC signal, the self-synchronizing inverters 614, 624, 634, 644 may cause the entire power grid system 600 to act as a replicable autonomous cooperative energy system that can create robust and scalable energy ecosystems. The power grid system 600 is a single nanogrid design that can be applied to a wide variety of applications while remaining agnostic to energy sources, storage type and technology changes, e.g., a relatively universal design. The design can be an economical nature-inspired solution, an unprecedented non-linear model and application of complex systems, to lack of access, scale, and adaptability of renewable energy globally.

FIG. 7 is a schematic diagram of self-synchronizing inverters 702 and 704, according to examples described herein. The self-synchronizing inverters 702 and 704 may include synchronization circuitry 712 and 714, respectively. In some examples, the synchronization circuitry 712 and 714 may include non-linear and chaotic circuits that may produce non-linear or chaotic behavior. AC signals from the self-synchronizing inverters 702 and 704 may be synchronized to one another with a reference connection, such as a voltage and/or current, between an output node of the self-synchronizing inverter 702 and an input node of the synchronization circuitry 712, as illustrated in FIG. 7.

In some embodiments, a switch 708 may have a terminal coupled to an output node of the self-synchronizing inverter 702 and another terminal coupled to a power bus 706. The synchronization circuitry 712 may receive an AC signal on the power bus 706 when the switch 708 is on. In some examples, the synchronization circuitry 712 may synchronize the AC signal from the self-synchronizing inverter 702 with the AC signal on the power bus 706 when the switch 708 is on. Similarly, a switch 710 may have a terminal coupled to an output node of the self-synchronizing inverter 704 and another terminal coupled to the power bus 706. The synchronization circuitry 714 may receive the AC signal on the power bus 706 when the switch 710 is on. In some examples, the synchronization circuitry 714 may synchronize the AC signal from the self-synchronizing inverter 704 with the AC signal on the power bus 706 when the switch 710 is on. Thus, AC signals from the self-synchronizing inverters 702 and 704 may be synchronized to the AC signal on the power bus 706, and when the switches 708 and 710 are on, and synchronized power output from the self-synchronizing inverters 702 and 704 may be provided on the power bus 706. While FIG. 7 is described herein to include the self-synchronizing inverters 702 and 703, in some examples, a system may include self-synchronizing electric machines wired in a similar connection relationship of the self-synchronizing inverters 702 and 703 to perform self-synchronization.

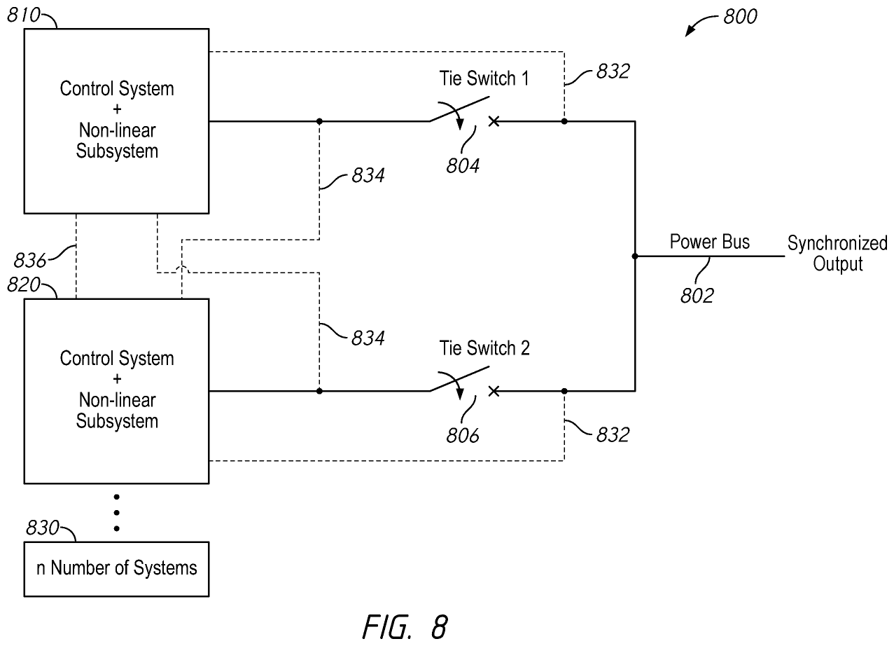

FIG. 8 is a schematic diagram of a system 800 including self-synchronizing systems 810, 820, 830, according to examples described herein. The self-synchronizing systems 810, 820, 830 include a self-synchronization capability and/or circuit, according to one embodiment of the present disclosure. The self-synchronizing system 810 may include a non-linear and/or chaotic circuit that may individually produce non-linear or chaotic behavior. The self-synchronizing system 810 may be synchronized to another self-synchronizing system 820 with reference connections 832, 834, 836, transmitting signals in a voltage and/or current, between the two self-synchronizing systems 810, 820. Self-synchronization may be performed in various ways using different connections. This is illustrated via a connection 836 between the self-synchronizing systems 810 and 820, connections 834 from the self-synchronizing system 810 or 820 to the self-synchronizing systems 820 or 810 respectively, and connections 832 coupled to the power bus 802. Thus, the non-linear or chaotic self-synchronizing systems 810 and 820 may interact with each other in order to achieve synchronization. This synchronization can be extended to an arbitrary number of self-synchronizing systems 830, as illustrated.

Self-synchronization of output AC signals is achieved using a non-linear or chaotic circuit interaction via the reference connections 832, 834, 836 shown in FIG. 8. Each of self-synchronizing systems 810, 820, 830 incorporates a non-linear or chaotic capability or characteristic that interacts via interaction signals on the reference connections 832, 834, 836. The non-linear or chaotic capability or characteristic may comprise or otherwise be implemented as a non-linear or chaotic circuit or simulation thereof. The interaction signals on the reference connections 832, 834, 836 may be a voltage or current or a combination thereof. Using this interaction via the interaction signal on the reference connections 832, 834, 836 combined with the non-linear or chaotic capability performance, the self-synchronizing systems 810, 820, 830 may naturally self-synchronize.

This approach to synchronization does not rely on master-slave topology or decentralized control systems with intelligence to control the system's voltage and frequency. As noted, synchronization of the voltage, frequency and phase angle is fundamental to maintain stability in an electrical power system. Synchronization leads to proper operation and load sharing capability of whatever sources are in question. Accordingly, this new approach to synchronization is significant.

FIG. 8 illustrates an interconnection of arbitrary n number of self-synchronizing systems 830, according to embodiments of the present disclosure. Each additional arbitrary self-synchronizing system 830 of the n number can be connected in parallel to the synchronized output and to an adjacent system (e.g., self-synchronizing system 820) in a similar manner as shown for the self-synchronizing systems 810 and 820. The synchronization may be performed when a plurality of self-synchronizing systems may otherwise interact, such as at the synchronized output on the power bus 802. When interacting, in terms of power, the final synchronized output on the power bus 802 may be a combination of the power produced or consumed by each of the self-synchronizing systems 810, 820, 830. In this example, each of the self-synchronizing systems 810, 820 is a producer (e.g., a generation source), and one or more of the arbitrary n number of self-synchronizing systems 830 may also be producers. Thus, the desired output on the power bus 802 may be an additive combination of the power produced from each of the self-synchronizing systems 810, 820, 830. When adding multiple AC waves, a highly desirable outcome is an efficient combination of energy, one where little to no energy is lost in the combination process.

Focusing on the synchronization of two self-synchronizing systems 810 and 820 to each other, by synchronizing the AC signals, their combined power output on the power bus 802 may be maximized. This means that the AC output of the self-synchronizing systems 810 and 820 are synchronized before switches 804 and 806 are closed. The tie switches 804 and 806 allow the AC signals from each of the self-synchronizing systems 820 and 830 to be output on the power bus 802 if the AC signals from the self-synchronizing systems 820 and 830 are synchronized with an AC signal in a distribution network. The power bus 802 may act as a grid connection to the distribution network. The switches 804 and 806 may allow the self-synchronizing systems 810 and 820 to remain isolated from the power bus 802, until their AC signals are synchronized to the AC signal on the power bus 802 or disconnected from the power bus 802 in the case of a fault. The switches 804 and 806 may include, but are not limited to, a manual breaker, an automatic transfer switch, a computer-controlled breaker, and any method or device by which the switches 804 and 806 may connect, disconnect, or reconnect responsive to control or fault detection.

The self-synchronizing systems 810 and 820 may use a variety of connections, including reference connections 832, 834, 836 to perform self-synchronization. Using the non-linear subsystem, the connection 832 serves as a subsystem-to-subsystem direct connection to achieve synchronization. The connection 834 is between self-synchronizing systems 810, 820 and the self-synchronizing systems 810, 820 may receive power from any other self-synchronizing system as a reference signal for self-synchronization. Each of the connections 832 may be a connection to an AC reference signal from each self-synchronizing system 810, 820 and each self-synchronizing system 810, 820 may use an AC reference signal, such as an AC signal on the power bus 802 connected to a distribution network, for self-synchronization. The self-synchronizing systems 810 and 820 may be paralleled to an n number of systems 830 where n is any natural number.

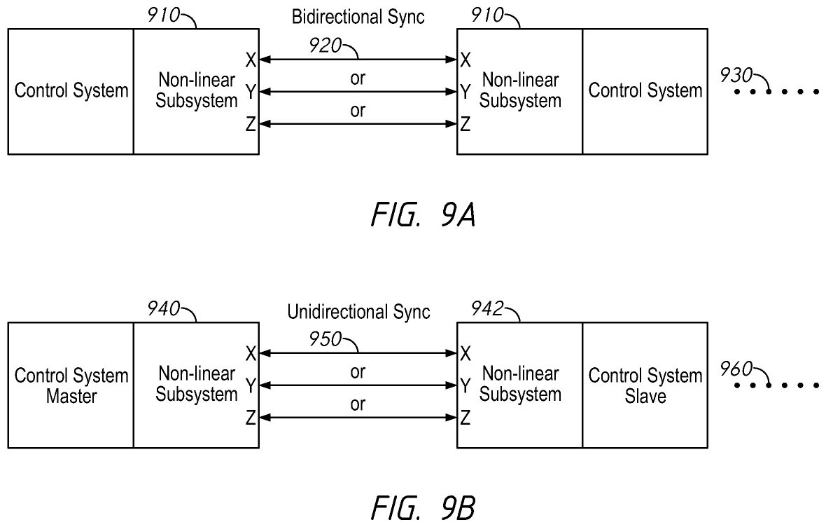

FIG. 9A is a schematic diagram of multiple non-linear subsystems 910 according to examples described herein. In some embodiments, the non-linear subsystems 910 may be used as power control systems of FIGS. 1-5. FIG. 9A illustrates an embodiment of bidirectional synchronization of systems. Interconnection methods of non-linear systems to perform self-synchronization are illustrated in FIG. 9A. The non-linear subsystems 910 may interconnect with one another in a manner that causes self-synchronization, with X, Y, or Z reference via bidirectional interconnections 920. In some examples, the X, Y, or Z reference may be a voltage and/or current reference on each system. An example of this interconnection is an X to X voltage connection, where the X voltage node of each system is connected and the systems self-synchronize. This self-synchronization may apply to n number of systems 930, where n is any natural number. The bidirectional interconnections (not shown) may allow the n number of systems to exchange information, in the form of voltage and/or current, between systems. The bidirectional interconnection 920 may allow the n number of systems to exchange information.

FIG. 9B is a schematic diagram of multiple non-linear subsystems 940 and 942 according to examples described herein. In some embodiments, the non-linear subsystems 940 and 942 may be used as power control systems of FIGS. 1-5. FIG. 9B illustrates an embodiment of unidirectional synchronization of systems. Interconnection methods of non-linear systems to perform self-synchronization are illustrated in FIG. 9B. A primary non-linear subsystem 940 may interconnect with a subordinate non-linear subsystem 942, that causes self-synchronization, with X, Y, or Z reference via unidirectional interconnection 950. In some examples, the X, Y, or Z reference may be a voltage and/or current reference on each system. An example of this interconnection is an X to X voltage connection, where the X voltage node of each system is connected and the systems self-synchronize. This self-synchronization may apply to n number of systems 960 where n is any natural number. The unidirectional interconnection 950 may restrict a direction of information flow from the primary non-linear subsystem 940 to the subordinate non-linear subsystem 942, which causes self-synchronization in a primary-subordinate configuration, where the primary non-linear subsystem 940 becomes the voltage and/or current reference for self-synchronization of subordinate non-linear subsystems 942. This self-synchronization may apply to n number of subordinate non-linear subsystems 942 connected to the primary non-linear subsystem 940 where n is any natural number. The unidirectional interconnection 950 may allow the n number of systems to exchange information.

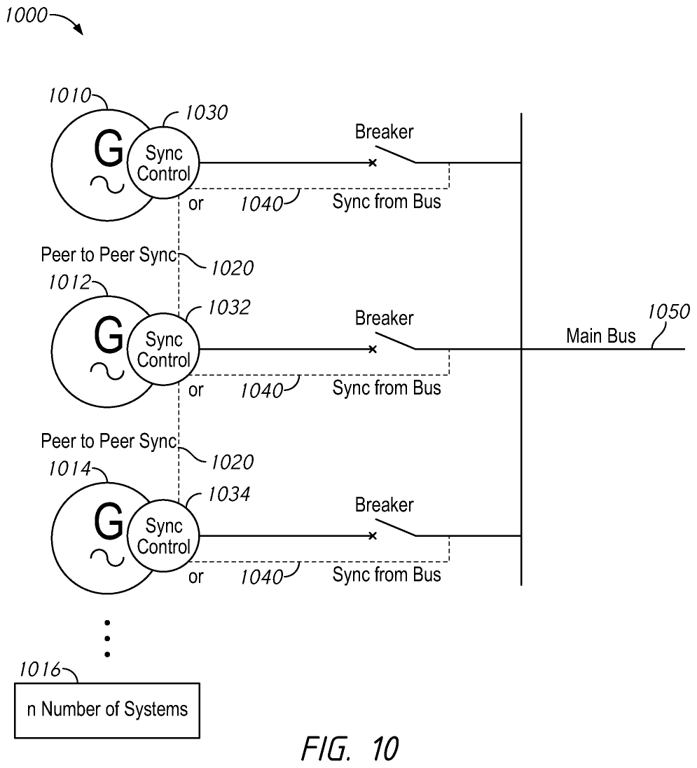

FIG. 10 is a schematic diagram of an electrical system 1000 including self-synchronizing drivers 1030, 1032, 1034, according to examples described herein. In some examples, the self-synchronizing drivers 1030, 1032, 1034 may be utilized in synchronizing the parallel operation of generators. In some embodiments, the electrical system 1000 may include generators 1010, 1012, 1014 that may be self-synchronized to one another by peer-to-peer synchronizing connection 1020. This arrangement may be scalable to include any number of generators, denoted by an arbitrary n number of generators 1016. The self-synchronizing drivers 1030, 1032, 1034 may be implemented into the generators 1010, 1012, 1014, respectively.

Actual synchronization between the generators and, in some cases, a centralized grid, may be achieved in a variety of ways. The electrical system 1000 may include synchronizing connection 1020 that provides a subsystem-to-subsystem direct connection to cause synchronization. The electrical system 1000 may include connection 1040 that is a subsystem to an AC reference, such as a power bus. The electrical system 1000 may include another connection 1050 that a subsystem may use to obtain an AC reference for self-synchronization, such as an AC signal in a grid or AC signal from another generator outside the electrical system 1000.

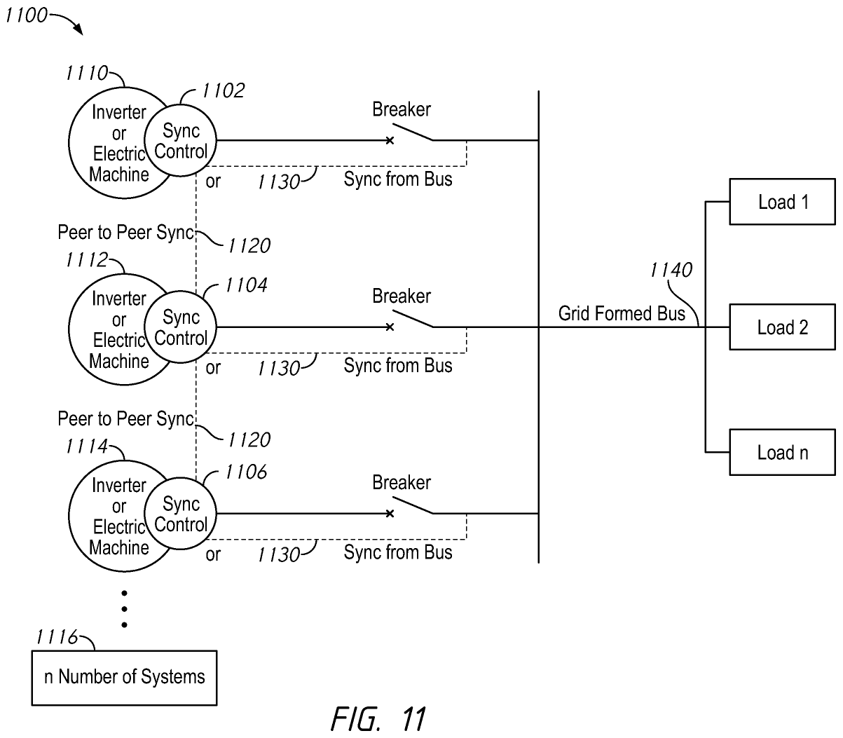

FIG. 11 is a diagram of an electrical system 1100 including self-synchronizing drivers 1102, 1104, 1106, according to examples described herein. The self-synchronizing drivers 1102, 1104, 1106 may be utilized in application to electric machines 1110, 1112, 1114 that may form a grid. The electrical system 1100 includes the electric machines 1110, 1112, 1114 that are self-synchronized to one another. This arrangement may be scalable to include any number of electric machines, denoted by an arbitrary n number of electric machines 1116. FIG. 11 illustrates one possible arrangement and/or use of self-synchronizing drivers 1102, 1104, 1106 within a multi-source formed grid (the electrical system 1100) that provides power to multiple loads via a power bus 1140. The electric machines 1110, 1112, 1114 may use a variety of connections, including peer-to-peer synchronizing connections 1120, that cause self-synchronization of the electric machines 1110, 1112, 1114. The electrical system 1100 may include connections 1130 that are subsystem-to-bus output connections where the subsystem may self-synchronize using an AC signal on the power bus 1140.

As described herein, power supply network systems including power control systems that perform AC power supply amount control and synchronization across AC power signals from a plurality of power sources. Each power control system may include self-synchronizing circuitry that may synchronize an AC signal based on a power source with an AC signal on a power bus that may provide power to loads. Each power control system may further include a controller that may control an amount of power to the power bus based on capacity information associated with power sources in the power supply network system. Thus, self-synchronization and AC power supply amount control may be performed in each power control system in an autonomous manner, regardless of the number of power control systems in a power supply network system. The power supply network system with autonomous synchronization and power supply adjustment provides scalability in a seamless and dynamic manner.

Examples described herein may refer to various components as “coupled” or “connected” or signals as being “provided to” or “received from” certain components. It is to be understood that in some examples the components are directly coupled one to another, while in other examples the components are coupled with intervening components disposed between them. Similarly, signals or communications may be provided directly to and/or received directly from the recited components without intervening components, but also may be provided to and/or received from the certain components through intervening components.

The description of embodiments of the disclosure is not intended to be exhaustive or to limit the disclosure to the precise forms disclosed. While the specific embodiments of, and examples for, the disclosure are described herein for illustrative purposes, various modifications are possible within the scope of the disclosure.

Specific elements of any foregoing embodiments can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

What is claimed is:

1. A power control system comprising:
an inverter configured to provide a first alternating-current (AC) signal from a first power source;
synchronization circuitry configured to couple to a power bus, the synchronization circuitry configured to synchronize the first AC signal with at least a second AC signal on the power bus; and
a controller coupled to the inverter, the controller configured to:
provide first capacity information associated with the first power source to a second power control system coupled to the power bus;
receive second capacity information associated with a second power source from the second power control system; and
control an amount of power to the power bus based on the first capacity information and the second capacity information.

2. The power control system of claim 1, wherein said control of the amount of power comprises evaluating a cost function.

3. The power control system of claim 1, wherein the controller is further configured to receive demand information, and
wherein said control of the amount of power is further based on the demand information.

4. The power control system of claim 1, wherein the synchronization circuitry comprises at least one of a non-linear circuit or a chaotic circuit.

5. The power control system of claim 1, further comprising a power line coupled to the inverter and the synchronization circuitry,
wherein the inverter is configured to receive a direct current (DC) signal from the first power source, to convert the DC signal into the first AC signal, and further configured to provide the first AC signal to the power line, and
wherein the synchronization circuitry is configured to receive the first AC signal from the power line, and further configured to provide the synchronized first AC signal on the power bus.

6. The power control system of claim 1, wherein each of the first and second power sources comprises at least one of solar photovoltaic (PV), a diesel generator, a fuel cell, a wind turbine, a hydroelectric facility, a bio-power source, an energy storage system (ESS), or any combination thereof.

7. The power control system of claim 1, wherein the first capacity information comprises at least one of a location of the first power source, maximum power output from the first power source, or minimum power output from the first power source.

8. The power control system of claim 1, further comprising an energy storage device coupled to the controller, wherein the first capacity information further comprises power storage capacity of the energy storage device.

9. The power control system of claim 8, further comprising a charge controller coupled to the energy storage device, and configured to control an amount of power to store in the energy storage device based on the amount of power to the power bus and the first capacity information.

10. The power control system of claim 9, wherein the controller comprises the charge controller.

11. A power supply network comprising:
a plurality of power sources;
a power bus;
a communication bus; and
a plurality of power control systems coupled to the power bus and the communication bus, each power control system comprising:
an inverter coupled to a corresponding power source of the plurality of power sources, the inverter configured to receive power from the corresponding power source and to provide an internal AC signal;
synchronization circuitry coupled to the power bus, the synchronization circuitry configured to synchronize the internal AC signal with an external AC signal on the power bus; and
a controller coupled to the inverter and further coupled to the communication bus, the controller configured to:
provide the communication bus with internal capacity information associated with the power source;
receive external capacity information associated with at least one external power source on the communication bus; and
control an amount of power to the power bus based on the internal capacity information and the external capacity information.

12. The power supply network of claim 11, wherein said control of the amount of power comprises evaluating a cost function.

13. The power supply network of claim 11, wherein the controller is further configured to receive demand information, and
wherein said control of the amount of power is further based on the demand information.

14. The power supply network of claim 11, wherein a plurality of corresponding synchronization circuitry of the plurality of power control systems are configured to synchronize the plurality of corresponding internal AC signals with the external AC signal.

15. The power supply network of claim 14, wherein the plurality of control systems comprise a first power control system and a second power control system, and
wherein the first power control system is configured to receive at least one of the external AC signal, an internal AC signal of the second power control system before synchronization from the second power control system, or the internal AC signal of the second power control system after synchronization to the power bus from the second power control system, and further configured to perform synchronization of the internal AC signal of the first power control system based on the received at least one AC signal.

16. The power supply network of claim 15, further comprising a reference power line between the first power control system and the second power control system,
wherein the first power control system is configured to receive the internal AC signal of the second power control system before synchronization on the reference power line.

17. The power supply network of claim 11, wherein the power supply network is configured to be coupled to another power supply network.

18. A non-transitory computer-readable storage medium, encoded with instructions, which, when executed by a first controller in a power supply network, cause the first controller to:
provide first capacity information associated with a first power source in the power supply network to a second controller in the power supply network;
receive second capacity information associated with a second power source from the second controller; and
control an amount of power to a power bus based on the first capacity information and the second capacity information.

19. The non-transitory computer-readable storage medium of claim 18, wherein said control of the amount of power comprises evaluating a cost function.

20. The non-transitory computer-readable storage medium of claim 19, wherein the instructions, which, when executed by the first controller, further cause the first controller to receive demand information, and
wherein said evaluating the cost function is further based on the demand information.
